(19) United States
(12) Patent Application Publication
(10) Pub. No.: US 2018/0099252 A1
(43) Pub. Date: Apr. 12, 2018

(54) A WINE OXYGENATION DEVICE AND METHOD

(71) Applicant: LINDE AKTIENGESELLSCHAFT, München (DE)

(72) Inventors: Thomas Bickford Holbeche, Church Crookham (GB); Dominik Michel, Munich (DE)

(21) Appl. No.: 15/567,177

(22) PCT Filed: Apr. 5, 2016
(86) PCT No.: PCT/EP2016/000557

§ 371 Date: Oct. 17, 2017

(30) Foreign Application Priority Data
Apr. 20, 2015 (EP) 15001163.3

(51) Int. Cl. B01F 3/04

(52) U.S. Cl. CPC B01F 3/04269; B01F 3/04801; B01F 2003/04319; B01F 2215/045; B01F 2003/04879; B01F 2215/0072; B01F 2215/0431; B01F 2003/04411

(57) ABSTRACT

A wine aerating device for adding oxygen containing gas into wine, the device comprising a gas cylinder containing pressurised gas which contains more than 21% oxygen by volume when measured at atmospheric conditions, a tube with a first end in fluid communication with the gas cylinder to a membrane which is in fluid communication with a second end of the tube, wherein the membrane is insertable through the neck of a wine bottle so that, in use, oxygen gas diffuses via the membrane into the wine, wherein the said membrane has a pore size of 0.1 μm to 10 μm, preferably 1 μm to 10 μm.

The present invention relates to a wine aerating device for adding oxygen gas into wine, the device comprising a cylinder containing pressurised gas which contains more than 21% oxygen by volume when measured at atmospheric conditions, a tube with a first end leading the gas from the gas cylinder through the tube to a membrane which is connected to a second end of the tube, wherein the membrane is insertable through the neck of the wine bottle so that, in use, oxygen gas diffuses via the membrane into the wine.

Adding controlled amounts oxygen to wine, or aerating the wine, is known to improve its taste. Typically, wine is aerated before use via a decanter or carafe. In a recent development wine can also be aerated using a venturi type system whereby the wine is poured from the bottle into an intermediary vessel above the wine glass, and the wine then aerated via the venturi effect as it passes from the intermediary vessel to the wine glass. Both of these aerating methods however are limited in terms of the rate of which air can be introduced into the wine.

The purpose of this invention is to improve the aerating method with higher and more effective flow rate of oxygen into the wine in a short time so the wine can be good aerated for getting a better taste just before consumption.

According to the present invention there is provided a wine aerating device according to claim 1.

The combination of the pressurised oxygen containing gas (allowing for a large amount of gas to be delivered) and the gas diffusing membrane (allowing for a controlled release of this gas) together allows a relatively high flow rate of oxygen gas to be diffused into the wine in a controlled manner. The tube is used to lead the gas from the gas cylinder to the membrane which should be inserted into a wine bottle. The tube has two ends which are connected separately with the side of the gas cylinder and with the membrane respectively.

The pressurised oxygen containing gas is contained in a gas cylinder which is provided which has a preferred small size and designed to be easily portable and disposable e.g. having an overall length of about 6.5 cm to 7.5 cm and a diameter of about 1.5 cm-2 cm. The cylinder as used herein refers generically to a container which is arranged for storing and releasing gas under pressure. The cylinder has a neck preferably which includes a top surface, an outlet and a side surface. The outlet of the cylinder is preferably enclosed by a breakable surface which can be opened by a piercing element such as a sharpened or blunt lance. The neck of the gas cylinder has a diameter of about 0.5 cm and a length of about 1.5 cm to 2 cm but other sizes are also possible.

Pressure ranges for such cylinders can range from around 20 bar to 300 bar and for the most commercial gas cylinder with the aforementioned size and shape the pressure ranges from around 150 bar to 200 bar, preferably 100 bar to 200 bar.

By having the membrane formed in one piece with pore size of 0.1 μm to 10 μm, could be 0.5 μm, 0.8 μm, preferably 1 μm to 10 μm, could be 1 μm, 2 μm, 3 μm, 5 μm, 7 μm and 9 μm, for a given volume of membrane, the membrane can have a large surface area for diffusing oxygen gas into the wine. By increasing this surface area to volume ratio of the membrane, the speed in which the wine can be aerated is also increased. Typically, there may be membrane with pore size of 1 to 5 μm. The diffusive effect of the membrane can produce small bubbles which allow the oxygen gas to be diffused efficiently into, and also quickly react, with the wine, which means less gas escape into the atmosphere. As a result, the pressured gas in the gas cylinder can be used for more wine, especially when the gas cylinder is formed so small for to be portable and convenient.

The membrane may be formed cylindrical whose axis has the direction of the axis of the tube. The diameter of the membrane is shorter than its length. The ratio of diameter and length should to be optimized in consideration of the contact surface area between wine and membrane as well as the gas distribution in the membrane so to ensure that as much of the wine in the bottle is aerated as possible. The membrane has a length of 35 mm to 150 mm, Preferable of 50 mm to 100 mm and a diameter of 8 mm to 16 mm Preferable of 10 mm to 14 mm and a wall thickness of 2 mm to 5 mm, preferably of 3 mm to 4 mm.

The bottom of the membrane which is vertical to the tube is non porous so the gas cannot pass through the bottom of the membrane into the wine but only through the central portion of the membrane. This special construction make the membrane more effective for passing the oxygen into the wine and forming small bubblies which increases the reaction of the oxygen with the wine in a short time.

Alternatively, the membrane is overall porous which means the oxygen containing gas can flow through the membrane by both the bottom and the side wall. The bottom is preferably round shaped to enhance the aeration performance.

The membrane is preferable sleek and not rough. It may have a roughness around R_{z} 1 to 50 preferable R_{z} 3 to 20.

The membrane may be made of a porous polymeric material to improve the amount of gas diffusing therethrough and reacting with the wine. An example material is porous polytetrafluoroethylene (PTFE) which is preferable hydrophobic and has no heavy metal and silicone.

A portion of the membrane may be made from a hydrophobic material. This way, during the aerating it will be difficult for the wine to adhere on the membrane so the device can keep clean easily.

Preferably, the surface of the membrane is hydrophilic. The hydrophobic membrane having a hydrophilic surface can advantagenously improve the performance of the wine aeration by generating fine bubbles all over along the membrane. The hydrophilic surface of the membrane is preferably formed by being treated by a plasma treatment which increases the energy of the surface of the membrane to increase its wettability and also impacts the surface tension of the membrane to favor the formation of fine bubbles.

The membrane has preferably a length of 50 mm, a diameter of 11 mm and a wall thickness of 3 mm to be equipped in the wine aerating device and to be inserted into a wine bottle to deliver the pressurized oxygen contained in the gas cylinder into the wine.

The membrane may also have another shape than cylindrical. It may have an increasing area of the cross-section in the direction from the first end of the tube to the second end of the tube. It may have a Xmas-tree-shape which has sloping walls on the both sides of the membrane. This special shape has the advantage that the angels formed by the sloping walls can break the small bubblies into even smaller size as they come from the pore of the membrane so a more effective reaction with the wine can be achieved.

The device may comprise a pressure limiting valve for lowering the pressure of the gas from the cylinder to a predetermined pressure before the gas reaches the membrane.

In this case, the valve may comprise a valve seat and a valve head, wherein the predetermined pressure is maintained by a spring means which controls the separation between the valve seat and the valve head. With the pressure limiting valve, the pressure of the gas passing through to the membrane can be better controlled.

The device may further comprise a mount for mounting the device on the neck of the wine bottle. This allows the membrane to be positioned towards the centre of the wine volume inside the bottle. In some embodiments, the mount may comprise a bung which is dimensioned to fit in the neck of the wine bottle. The mount may alternatively or additionally comprise a plurality of legs which are each dimensioned to extend down the outside surface of the neck of the wine bottle. It will be appreciated however that the mount may have any shape necessary to achieve the intended positioning effect.

The device may further comprise a piercing element for piercing a seal on the cylinder. With the piercing element, the device can be used with gas cylinders which are sealed by a weld. With such cylinders, the piercing element, which may be in the form of a hollow tube, can pierce the weld to allow gas to escape from the cylinder and into the device.

The device is preferably portable and can be held by hands to operate the aeration of wine.

The cylinder, the tube, and the membrane may be co-axial to provide an easily determinable centre of gravity for the device. This axis may extend through the neck of the wine bottle when the device is placed thereon. With this arrangement, when the device is placed on the bottle, the device's centre of gravity is more likely to act through the neck of the wine, ensuring that the device is stable on the bottle.

The pressurized gas contains more than 21% vol. oxygen when measured at atmospheric pressure. It contains preferably more than 50% oxygen, more preferred more than 80% vol., particular preferred more than 90% vol. more particular preferred more than 99% vol. The pressurized gas may be also technical pure oxygen. According to a second aspect of the present invention there is provided a method of adding oxygen containing gas to a volume of wine, especially a bottle of wine according to claim 9. The bottle could have a volume of 0.51, 0.751, 11 or 21.

Preferably, the pressure in the gas cylinder and the size of the tube and membrane are fitted to be able to aerate wine, preferred a red wine to an oxygenation level of 20 to 40 mg/I of solved oxygen. It could be 25 mg/I, 30 mg/I, 35 mg/l of solved oxygen. The flow rate of the oxygen from the gas cylinder to wine is preferably from about 20 ml/min to 80 ml/min, more preferably from 20 ml/min to 60 ml/min, much more preferably 30 to 50 ml/min in a period of 0 60 seconds to 360 seconds such as 100 second preferable a period of 120 seconds to 300 seconds. It could be 160 seconds, 180 seconds, 240 seconds which depends on the type of the wine. Being able to aerate such quantities of wine with this flow rate in this time interval is clearly useful to the end consumer of wine, since they are readily able to aerate a wine bottle just before serving, much more quickly and effectively than with a decanter, carafe, or venturi type aerator.

The microbubbles which are generated by the membrane have an average diameter of 0.3 to 300 μm, could be 150 μm, 200 μm, 250 μm, preferable of 0.5 to 100 μm such as 1 μm, 5 μm, 10 μm, 30 μm, 50 μm, 70 μm, 90 μm which is very fine and thus enables a great contact surface between the oxygen and the wine to make the aeration of the wine more quickly and effectively.

When gas flows from the cylinder, the pressure of the gas at the membrane may be reduced to 50% of the pressure inside the cylinder. More preferably, the pressure at the membrane may be reduced to 25% of the pressure inside the cylinder. Even more preferably, the pressure at the membrane may be reduced to 10% of the pressure inside the cylinder. Still more preferably, the pressure at the membrane may be reduced to 4% of the pressure inside the cylinder. By increasing the pressure in the cylinder and having a large pressure drop, this allows the cylinder to be made smaller and more compact.

In this method, the membrane may comprise any of the preferred features described above.

In this method, the wine may be contained in a wine bottle and the method may further include the step of inserting the membrane through the neck of the wine bottle.

It will also be appreciated that any form of pressurised gas source may be used. Indeed, the gas cylinder described above may be single use, replaceable or refillable. The device may be manufactured and distributed with or without a pressurised gas cylinder.

The present invention will now be described with reference to the following Figures in which:

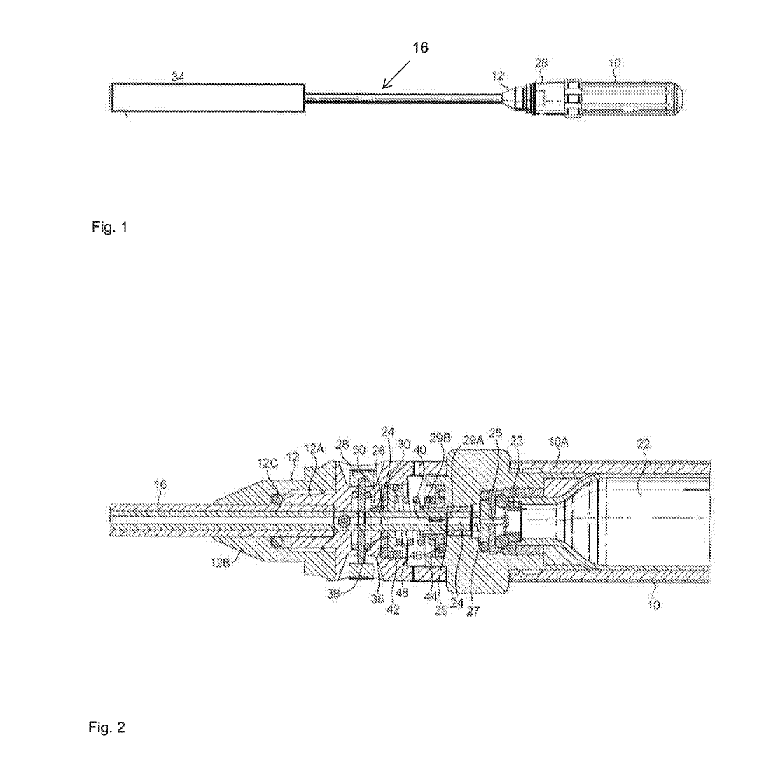

FIG. 1 shows a plan view of the aerator assembly;

FIG. 2 shows a more detailed section view of the portion of the aerator assembly between the gas cylinder and the membrane.

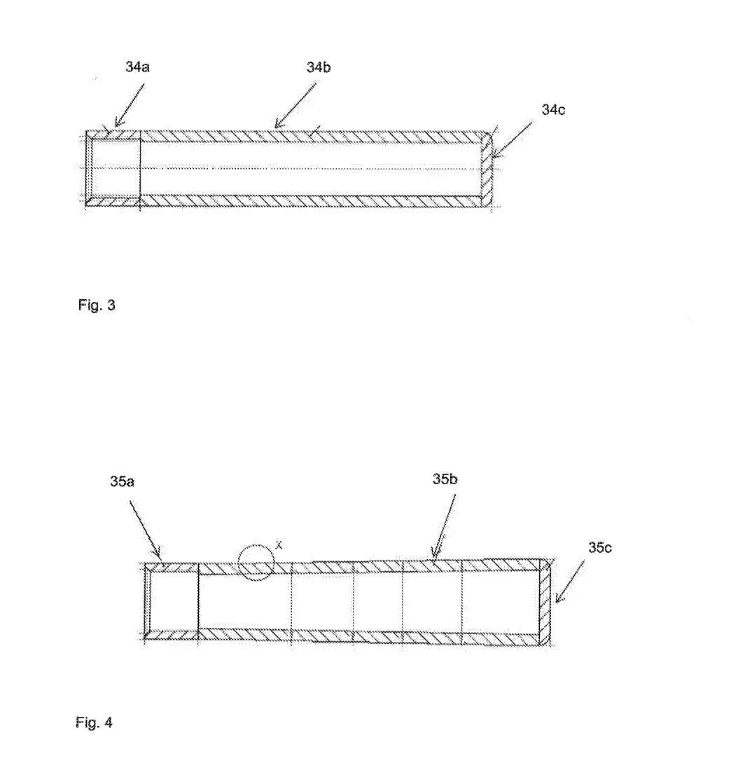

FIG. 3 shows a section view of the membrane

FIG. 4 shows a plan view of a Xmas-tree membrane

FIG. 5 shows an enlarged view of X of FIG. 4

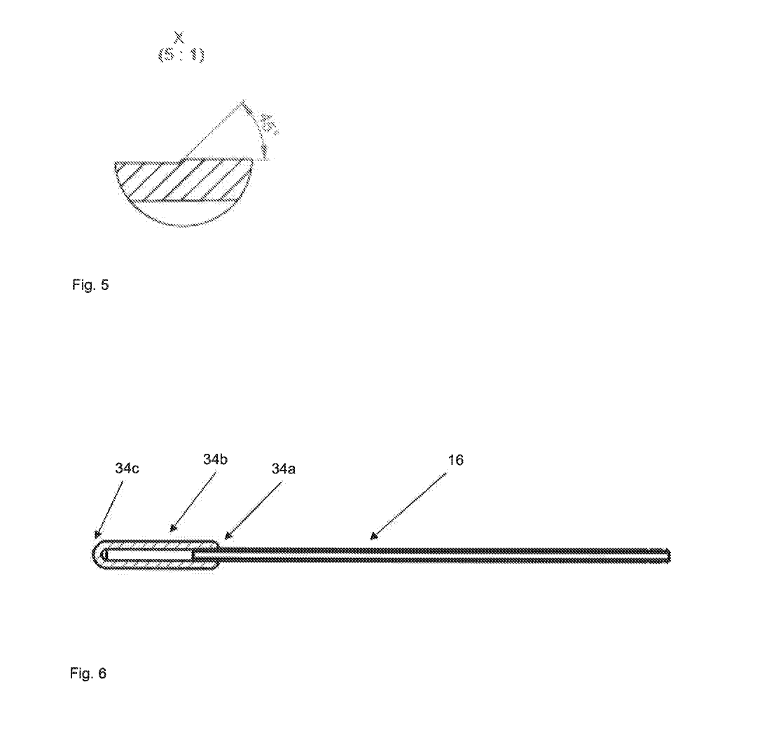

FIG. 6 shows a plan view of an alternative membrane.

Henceforth, the word ‘downstream’ means towards the membrane end of the gas path and the word ‘upstream’ means towards the cylinder end of the gas path.

The aerator assembly shown in the FIG. 1 is formed of three main parts: a body 10 for holding a gas cylinder, a single body membrane 34, and a central tube 16 which connects the body and the membrane together. The membrane 34 is cylindrical in shape and is elongate in the direction of insertion and also the elongate axis of the surrounding wine bottle. In use, the aerator assembly is arranged to engage with the neck of a wine bottle which has a fluid content of 0.75 l (not shown). The aerator assembly may be compatible however with larger bottles if desired, for instance a Magnum or a Jereboam.

As shown in FIG. 2, an interface 12 connects the body 10 to the tube 16. The interface 12 is formed of a first section 12A which forms part of the body 10 and a second section 12B which connects to and surrounds a portion of the tube 16. The second section 12B connects to the first section 12A via a push in fitting. In their connected state, the two sections 12A; 12B of the interface 12 form a conical shape which is dimensioned to fit inside the neck of the wine bottle.

To ensure a fluid seal between the two sections when they are connected, the first section 12A comprises a sealing O-ring 12C which engages with the second section 12B.

Although not shown, a number of optional resilient legs may be present which emanate from the interface and which are shaped to conform to the sloping surface defining the neck of the wine bottle, and which help ensure that the aerator assembly is correctly located over the wine bottle outlet.

A pressurised gas cylinder 22 connects to the top of the body 10 by a screw thread (not shown) located on the body 10. The gas cylinder 22 can contain pressurised air, though preferably it contains pressurised gas containing more than 21% oxygen by volume, most preferably 100% oxygen, (when measured at atmospheric conditions) at a pressure between 20 bar and 300 bar. As shown best in FIG. 1D, the cylinder 22 comprises a welded film 23, which is perforated by a piercing tube 25 on the device when the cylinder is connected thereto. A cover portion 10A of the body 10 surrounds the cylinder 22 in use.

Downstream from the gas cylinder 22 is a fluid channel 24 which extends completely through the body 10.

The fluid channel 24 initially extends from the piercing tube 25 and passes through a filter block 27 in the body 10 for removing any impurities or particulates in the gas coming from the cylinder 22.

Downstream from the filter block 27 and inside the channel 24 of the body 10 is a valve 29 formed of an upstream valve seat 29A and a downstream valve head 29B which is engageable with the valve seat. The valve 29 is responsible for throttling the pressure of the gas in the cylinder, which is around 20 bar and 300 bar, down to a pressure of approximately 2 bar 4 bar which is suitable for use in the membrane as will be described.

Opening and closing of the valve 29 is controlled by a pressure regulation system 36 located inside a cavity 30 inside the body 10 downstream from the valve 29.

The pressure regulation system 36 comprises, at its downstream end, an actuation surface 38 which seals against the body 10 by an O-ring 42. The regulation system also comprises an elongate central piston 40 located inside the fluid channel 24 and which engages with the actuation plate 38. The upstream end of the elongate piston 40 is engageable with the valve head 29B and contains a fluid channel (not shown) extending through its elongate length to allow gas flow through the piston as will be described.

At the upstream end of the regulation system, i.e. the end closest the cylinder 22; an abutting plate 44 inside the cavity 30 abuts the body 10 via a separating O-ring 46. A compression spring 48 is located between the actuation plate 38 and the abutting plate 44 to bias the actuation plate in a downstream direction.

In use, the actuation plate 38 is acted upon by pressurised gas. If the pressure of this gas is too high, the pressure of the gas will overcome the biasing force from the compression spring 48, thus moving the actuation plate 38 and the piston 40 in an upstream direction. In so doing, the piston 40 moves the valve head 29B towards the valve seat 29A, which causes the valve 29 to reduce the pressure of subsequent gas passing through the valve.

Downstream of the pressure regulation system 36, an offset fluid channel 50 forms the continuation of the fluid channel 24. The offset fluid channel 50 is selectively closable by a valve member 26, which is operated by a slidable switch 28 located on the outside surface of the body 10. In the position shown in FIG. 1D, the offset fluid channel 50 is blocked by the valve member 26.

Downstream of the valve member 26 is a tube 16 which extends downwardly inside the wine bottle.

At the bottom of the tube 16 is a membrane 34 which is connected with the tube 16. In use, the membrane immersed in the wine to be aerated as will be described. The membrane 34 is around 100 mm long and a diameter of 10-14 mm. The material used in membrane is preferentially hydrophobic so the wine can be easily rinsed off from the component after it has been immersed in the wine.

As shown in FIG. 3, the membrane 34 comprises a top, central and bottom portion 34a; 34b; 34c. The tube 16 enters the membrane sealed at its top portion 34a to lead the gas to central portion 34a for aerating the wine. The bottom portion 34c of the membrane is a dense surface where the oxygen cannot pass through. The central portion 34b is the effective part for the oxygen aerating which uses a porous material with pore size of 1 to 10 μm, especially of 1 to 5 μm. The oxygen flows into the space which is defined by the membrane 34 through the tube and releases into the wine through the fine holes of the central portion 34b by forming fine bubbles. As a result, the oxygen has larger contact surface area with the wine to increase the oxygen content in the wine with less gas lost which only passes through the wine and escapes into the atmosphere.

The membrane is selected or designed in a way that during the aeration the content of oxygen in the wine can be increased in a short time and after the aeration the membrane is easy to rinse. An optimal results is achieved e.g. by a membrane made of porouse PTFE (Polytetrafluoroethylene) which is hydrophobic and without PFOA (Perflurorooctanoic) and heavy metal and silicone with a hole size of 1 to 5 μm and which is designed cylindrical with a length of 50 mm and a diameter of 11 mm and a wall thickness of about 3.25 mm. This membrane is also particularly effective at producing bubbles with a small size which can aerate a wine 0.75 l with a flow rate of 30 to 50 ml/min in a period of 120 seconds to 360 seconds.

As shown in FIG. 4, a variation of the membrane is formed with a Xmas-tree shape which has an increasing cross-section downstream of the central portion 35b which is graded by sloping walls as shown in area X. This sloping walls built sloping angles of e.g. 45° as shown enlarged in FIG. 5 which perform effective for breaking the bubbles in smaller size as they came from the membrane, so the formed bubblies will be further reduced to causing the oxygen react with the wine more effectively.

The FIG. 6 shows a plan view of an alternative membrane 34 which can be configurated in the device shown in FIG. 1. Unlike the membrane in FIG. 3, the membrane here has a round shaped bottom 34c which has the same material as the other parts of the membrane. The gas from the gas cylinder can therefore pass through allover the membrane 34. The membrane 34 is connected with the tube 16 by pressing the top portion of the membrane 34a to the tube which is preferably made of stainless steel so as to ensure that the gas from the gas cylinder flow into the wine only through the membrane. Preferably, at the second end of the tube 16 where is to be connected with the membrane 34, several rolled barbs are provided to hook the membrane gas-tightly.

When the gas cylinder 22 is initially connected with the body 10, the pierceable tube 25 pierces the welded film 23 on the gas cylinder 22 to allow high pressure gas to pass from the cylinder into the body 10. This high pressure gas then passes along the fluid channel, past the filter block 27, and past the valve 29. In passing between the cylinder and the valve 29, the gas is throttled from the pressure inside the gas cylinder down to a lower pressure of between 2 bar 4 bar. The lower pressure gas then passes through the fluid channel inside the piston 40 and out from its downstream end. Before passing though the offset fluid channel 50, a portion of the gas acts on the actuation plate 38. As mentioned previously, if the pressure of this downstream gas is too high, the pressure of the gas will overcome the biasing force from the compression spring 48, thus moving the actuation plate 38 and the piston 40 in an upstream direction. In so doing, the piston 40 moves the valve head 29B towards the valve seat 29A, which causes the valve 29 to reduce the pressure of subsequent gas passing through the valve.

Downstream of the actuation plate 38, the lower pressure gas then enters the offset fluid channel 50. When the valve 26 is toggled open, the pressurised gas from the offset channel 50 then passes past the valve 26 and into the tube 16 as will be described. When enough gas has passed through the assembly, the valve 26 is then toggled closed (as shown in FIG. 3), which thus blocks the offset channel 50, preventing further gas from reaching the tube 16.

When gas enters the tube 16, it subsequently passes into the membrane 34. When entering membrane 34; the oxygen containing gas is above atmospheric pressure. The wine itself is at atmospheric pressure. As a result, a pressure gradient is formed between the interior and exterior surfaces of the membrane 34 which causes the pressurised gas to diffuse through the membrane 34 and react with the wine. The membrane has a relatively high surface area which means that it can achieve a fast diffusion rate of gas therethrough. Due to the material used in the membrane, the gas which diffuses therethrough forms bubbles with a small mean bubble size. As a result of these small bubbles, the gas thus quickly diffuses and reacts with the wine.

1-15. (canceled)

16. A wine aerating device for adding oxygen containing gas into wine, comprising:
a gas cylinder containing pressurised gas including more than 21% oxygen by volume when measured at atmospheric conditions; and
a tube having a first end in fluid communication with the gas cylinder, and a second end in fluid communication with a membrane, the membrane being insertable through a neck of a wine bottle for oxygen gas to diffuse via the membrane into the wine, the membrane comprising pores having sizes selected from the group consisting of from 0.1 μm to 10 μm, and 1 μm to 5 μm.

17. The device of claim 16, wherein the membrane is cylindrical and comprises a diameter having a length shorter than a length of the membrane, and an axis in a direction similar to an axis of the tube.

18. The device of claim 16, wherein the membrane is made from a material selected from the group consisting of a polymeric material, a hydrophobic material, and hydrophobic polytetrafluoroethylene.

19. The device of claim 16, wherein the oxygen gas flows through the membrane and generates microbubbles into the wine, the microbubbles comprising an average diameter selected from the group consisting of from 0.3 to 300 μm, and from 0.5 to 100 μm.

20. The device of claim 16, wherein the membrane is sleek and comprises a roughness selected from the group consisting of from R_{z} 1 to 50, and from R_{z} 3 to 20.

21. The device of claim 16, wherein the gas cylinder contains a percentage of oxygen selected from the group consisting of more than 80 vol.-% oxygen, and more than 99 vol.-% oxygen.

22. The device of claim 16, wherein the membrane comprises a hydrophilic surface.

23. The device of claim 22, wherein the hydrophilic surface is formed by a plasma treatment.

24. The device of claim 16, wherein the membrane is cylindrical comprising a length selected from the group consisting of from 35 mm to 150 mm, and from 50 mm to 100 mm; and a diameter selected from the group consisting of from 8 mm to 16 mm, and from 10 mm to 14 mm; and a wall thickness selected from the group consisting of from 2 mm to 5 mm, and from 3 mm to 4 mm.

25. The device of claim 16, wherein the device is portable.

26. A method of adding oxygen containing gas to a volume of wine, comprising:
passing oxygen from a gas cylinder through a membrane into the wine, wherein a flow of the oxygen through the membrane is at a rate selected from the group consisting of from 20 ml/min to 80 ml/min, from 30 ml/min to 60 ml/min, and from 30 ml/min to 50 ml/min; and a period of time for the flow rate is selected from the group consisting of from 80 seconds to 360 seconds, and from 120 seconds to 300 seconds.

27. The method of claim 26, wherein a pressure inside the gas cylinder when full is a pressure selected from the group consisting of from 20 bar to 300 bar, and from 100 bar to 200 bar.

27. The method of claim 26, wherein a pressure inside the gas cylinder when full is a pressure selected from the group consisting of from 20 bar to 300 bar, and from 100 bar to 200 bar.

28. The method of claim 26, wherein the device can supply 20 to 40 mg/l wine of solved oxygen measured at atmospheric conditions to 0.75 l of wine in a period of time selected from the group consisting of from 60 seconds to 360 seconds, and from 120 seconds to 300 seconds.

29. The method of claim 26, further comprising treating the membrane with a plasma treatment.

30. The method of claim 26, further comprising containing the wine in a wine bottle, and inserting the membrane through a neck of the wine bottle.
